(19) United States
(12) Patent Application Publication
(10) Pub. No.: US 2009/0195946 A1
(43) Pub. Date: Aug. 6, 2009

(54) Electrostatic Discharge Protection Using an Intrinsic Inductive Shunt

(75) Inventor: Bendik Kleveland, Santa Clara, CA (US)

Correspondence Address: THE MUELLER LAW OFFICE, P.C., 12951 Harwick Lane, San Diego, CA, 92130, US

(73) Assignee: ZEROG WIRELESS, INC., Sunnyvale, CA (US)

(21) Appl. No.: 12/026,527

(22) Filed: Feb. 5, 2008

(51) Int. Cl. H02H 9/04

(52) U.S. Cl. 361/56

(57) ABSTRACT

In one embodiment of the present invention, an electrostatic discharge protection circuit provides efficient electrostatic discharge protection to an RFIC. The circuit includes several parts such as an inductor coupled from a first rail to an internal node. A power amplifier transistor having a transconductance control node is coupled to internal circuitry, a first terminal coupled to a second rail, and a second terminal coupled to an internal node. The circuit also comprises a pad coupled to an internal node, and this pad is capable of being coupled to off chip systems such as an antenna. The power amplifier transistor serves as the active device for an RF power amplifier. The inductor serves as one of either a bias inductor or a tank inductor for the RF power amplifier. Additionally the inductor acts as a low impedance path to the first rail to protect the power amplifier transistor during an ESD pulse.

### FIELD OF THE INVENTION

The invention relates generally to electrostatic discharge (ESD) protection circuits, and more specifically to ESD protection circuits for Radio Frequency (RF) circuits.

### BACKGROUND OF THE INVENTION

The diminishing feature size of electronic integrated circuits (ICs) has brought the benefit of both lower cost and lower power consumption to electronic systems. Modern IC manufacturers operating at an advanced lithographic node can achieve MOS field-effect transistor (MOSFET) channel lengths of 65 nm and dielectrics of 1.2 nm. This decrease in feature size has increased the susceptibility of IC's to electrostatic discharge (ESD) events. ESD is a common phenomenon that expresses itself in a static shock felt when one's skin is brought into contact with metallic surfaces on dry winter days. The human body can act as a capacitor that builds up charge through an effect known as tribocharging which occurs when two different materials, such as a person's shoes and a carpet, are brought together and then separated. The shock is the result of this charge discharging rapidly to a lower potential. ESD events detectable to human perception are orders of magnitude greater than those capable of damaging the delicate components of modern electronic circuits. ESD is a leading cause of electrical overstress and resultant irreversible damage in electronic circuits and must be considered throughout the design, manufacturing, and distribution process.

Integrated circuits are encased in insulating packages that protect them from ESD events but their input and output (I/O) pins must necessarily be conductive for the circuit to communicate electronically with external systems. The purpose of ESD protection circuits is therefore to delineate electronic signals received at the pins that the circuit receives for power and information processing from the electronic signals that are the result of ESD. The most common technique for ESD protection circuits is to trigger a secondary path for the ESD signals when they are detected. In this regard, the operative action of an ESD protection circuit can be compared to the action of a lightning rod protecting a building. As a lightning rod is connected to conductive paths that divert the energy of a lighting strike to ground without damaging the building, an ESD circuit provides conductive paths from a set of pins to another without damaging the internal circuit.

The filtering aspect of ESD protection circuits needs to be designed to react to the typical characteristic of an ESD signal and not to the typical characteristics of operational signals. ESD events in ICs are characterized by large currents, large voltage potentials, and rapid transients. ESD events typically have energy spectrums that are negligible in the higher than 1 GHz operating frequency range of RF microwave circuits. A standard characteristic for an ESD event is described by the Human Body Model (HBM) which is used to model the effect of a charged human person coming into contact with a packaged integrated circuit. The RC discharge time of the HBM pulse is much slower than typical RF microwave application frequencies. The fastest ESD phenomenon is the Charged Device Model (CDM) which has a rise time on the order of 250 ps. The energy spectrum of the CDM extends into frequencies typical of RF microwave applications but is negligible above 5 GHz. Another commonly applied characteristic is the Machine Model (MM) whose energy spectrum is placed between the CDM and HBM patterns. The robustness of a particular circuit is determined by applying ESD signals that are characterized by these models at progressively higher voltages. The industry standard typically requires a circuit to be able to withstand a 2000V pulse applied with the HBM characteristic, a 200V pulse applied with the MM characteristic and 1000V pulse applied with the CDM characteristic.

The three main failure mechanisms in the internal circuitry of an IC caused by ESD events are thermal breakdown caused by the heat from large currents, dielectric breakdown from large voltage potentials, and metallization melt from large currents. Thermal breakdown is also called avalanche degradation and will occur in the pn-junctions that form MOSFETs and bipolar junction transistors (BJTs) when they are forced to conduct excessive currents. Dielectric breakdown is also known as oxide punch-through and is caused by excessive voltage potential differentials across the gate of a MOSFET. The dielectric of a typical MOSFET is 8×10⁶ V/cm which can translate to a dielectric breakdown of as little as 0.96V given the minimum achievable gate widths available in modern semiconductor manufacturing processes.

FIG. 1 displays a traditional ESD protection circuit. If an ESD event occurs that places I/O pin 100 at a higher potential than power rail V_{DD} diode 101 will be forward biased and current will flow from pin 100 to V_{DD}. If the voltage at V_{DD} rises beyond a set limit ESD clamp circuit 104 will conduct current from V_{DD} to ground node V_{SS}. If an ESD event occur with the opposite polarity and the voltage at I/O pin 100 drops below V_{SS} diode 102 will be forward biased and current will flow from V_{SS} to pin 100. If the voltage at V_{SS} drops past a set limit ESD clamp circuit 104 will again conduct current from V_{DD} to ground node V_{SS}. In either of these circumstances the reaction of the ESD circuit will supply current to or sink current from pin 100. The result of this reaction is that the voltage at pin 100 will not induce dielectric breakdown in any of the devices in protected circuit 103 and large currents will not flow into protected circuit 103. Current limiting resistor 105 can also be included in the ESD scheme to divert current away from protected circuit 103.

FIG. 2 displays a typical ESD clamp circuit. This simple circuit contains gate-grounded n-type MOS (NMOS) 200. For typical values of V_{DD} and V_{SS} the MOS remains in the off state since the voltage from gate to source remains less that the threshold voltage of the device. If the voltage from V_{DD} to V_{SS} becomes too large, the device undergoes snapback where the source, drain, and substrate form a forward biased NPN BJT which conducts current from V_{DD} to V_{SS}. This type of ESD clamp is described in U.S. Pat. No. 5,780,897 to Krakauer.

The implementation of RF functionality on a MOS integrated circuit is a fairly recent development that has been in response to and has enabled the recent proliferation of portable wireless communication devices. Power Amplifiers (PAs) are a necessary component of RF circuits that amplify a signal to be transmitted. FIG. 3 displays an NMOS PA output stage. NMOS 302 is in common-source configuration. The signal to be amplified is applied to node Vᵢₙ. Inductor 300 is also called a radio frequency choke or tank inductor and can sustain both positive and negative voltages. The amplified signal is produced at node Vₒᵤₜ and is transmitted by antenna 301.

Traditional ESD protection circuits are not capable of protecting this new class of integrated circuits for two reasons. As explained in reference to FIG. 1, ESD protection conduction paths are triggered when the voltage at the I/O pins swings out of the range of V_{DD} to V_{SS}. The reason this works as a method for delineation is that the signals that contain system information in a traditional IC have voltages that are below the power supply voltage. As mentioned in reference to PAs, there are salient information laden signals at the I/O pins outside of the V_{DD} to V_{SS} range in RF applications. The second reason is that ESD protection devices introduce parasitic capacitance to the I/O pad. RF circuits require high speed so they are extremely susceptible to delay and signal loss caused by parasitic capacitances.

One solution to the problem of parasitic capacitance in an ESD protection circuit is described in U.S. Pat. No. 6,509,779 to Yue. This reference takes advantage of the fact that ESD events have energy spectrums centered around much lower frequencies than the salient electronic signals on which RF circuits operate. The impedance of an inductor increases with frequency according to the equation:

Z=2*π*f*L

Where Z is the impedance, L is the inductance, and f is the frequency. The Yue circuit takes advantage of this characteristic by placing an inductor in series with the ESD device. In this manner the inductor acts as a filter allowing the ESD device to conduct current from the I/O pin to ground at low frequency but not at high frequency. The overall effect of such a circuit is that the ESD device can conduct current and protect the circuit during an ESD event but does not provide a current path at higher frequency for signal loss to occur.

Another group of circuits that address the problem of parasitic capacitance in RF ESD circuits takes advantage of the fact that an inductor and conductor in parallel have very large impedance at a specific frequency. The pair of devices is called an LC pair and the frequency of large impedance is known as the resonant frequency. The resonant frequency can be expressed in radians by the equation:

wₒ=1/(LC)^{1/2}

Where wₒ is the resonant frequency, L is the inductance of the inductor, and C is the capacitance of the capacitor. The LC pair behaves like a notch filter because it has high impedance at the resonant frequency, but its impedance decreases rapidly as the distance between the frequency under consideration and the resonant frequency increases.

The first method that utilizes this principle places a bond wire with an adjustable inductance in parallel with a typical ESD protection diode. In such a circuit the value of C in the above equation is equivalent to the parasitic capacitance of the ESD protection diode (C_{ESD}) and L is equivalent to the adjustable inductance of the bond wire (L_{ESD}). By setting L_{ESD} so that the resonant frequency is equivalent to the operating frequency of the circuit the LC pair presents a high impedance path at the operating frequency and very little signal energy is lost through this path. The result of such a technique is that the parasitic paths are tuned out from affecting the circuit at the operating frequency. A description of such a method can be found in E. Rosenbaum, Diode-based tuned ESD protection for 5.25-GHz CMOS LNAs, Proc EOS/ESD Symp 2005; 9-17.

Another circuit that applies resonance to cancel the effect of the parasitic capacitance of ESD devices is displayed in FIG. 4. The circuit takes advantage of the notch filter characteristic of LC pairs to isolate the effect of the ESD devices from I/O pin 400 at the operating frequency of the circuit. The LC pairs comprised of inductors 404 and 402 and capacitors 405 and 403 are selected so that their resonant frequency is equivalent to the operating frequency of the circuit. At the resonant frequency of the circuit the LC pairs have very high impedance. This action of the LC pairs isolates ESD parasitic capacitors 409 and 410 from the signal path between I/O pin 400 and the protected circuit 407. At frequencies commensurate with ESD events the LC pairs have very low impedance so the circuit behaves in a similar manner to that described in reference to FIG. 1. ESD protection diodes 406 and 401 are connected to I/O pin 400 through a conductive path and may route ESD transient currents through ESD clamp 408 around protected circuit 407. U.S. Pat. Nos. 6,885,534 and 7,009,826 to Ker disclose circuits that relate to this technique.

Another set of ESD protection schemes that use inductors are disclosed in U.S. Pat. No. 6,624,999 to Johnson and U.S. Pat. No. 7,129,589 to Behzad. The difference between the methods provided in these two patents and those discussed previously is that an inductor acts as an ESD protection device on its own and is not meant to cancel out the capacitance of another ESD device. As mentioned previously, the impedance of an inductor increases with frequency. Therefore, an inductor can be selected that provides a low resistance path for ESD currents at the low frequencies where such currents take effect and a high resistance path during usual RF high frequency operation. The approach disclosed in U.S. Pat. No. 7,129,589 includes an on-chip inductor meant to serve as an ESD protection device that provides a low impedance path to ground at the low frequencies associated with ESD events. The PA is then tuned using another inductor in the form of a bond wire attached from the output of the PA to a separate pin used specifically for the bond wire inductor. The approach described in U.S. Pat. No. 6,634,999 is similar but it is applied to a differential PA with an off chip load. As a result of this different configuration, there are multiple ESD inductors. In this approach the ESD inductors are built into the package substrate of the IC.

### SUMMARY OF INVENTION

In one embodiment of the present invention, an electrostatic discharge protection circuit provides efficient electrostatic discharge protection to an RFIC. The circuit includes several parts such as an inductor coupled from a first rail to an internal node. A power amplifier transistor having a transconductance control node is coupled to internal circuitry, a first terminal coupled to a second rail, and a second terminal coupled to an internal node. The circuit also comprises a pad coupled to an internal node, and this pad is capable of being coupled to off chip systems such as an antenna. The power amplifier transistor serves as the active device for an RF power amplifier. The inductor serves as one of either a bias inductor or a tank inductor for the RF power amplifier. Additionally the inductor acts as a low impedance path to the first rail to protect the power amplifier transistor during an ESD pulse.

### BRIEF DESCRIPTION OF THE DRAWINGS

FIG. 1 illustrates a typical ESD protection circuit using diodes and a power clamp.

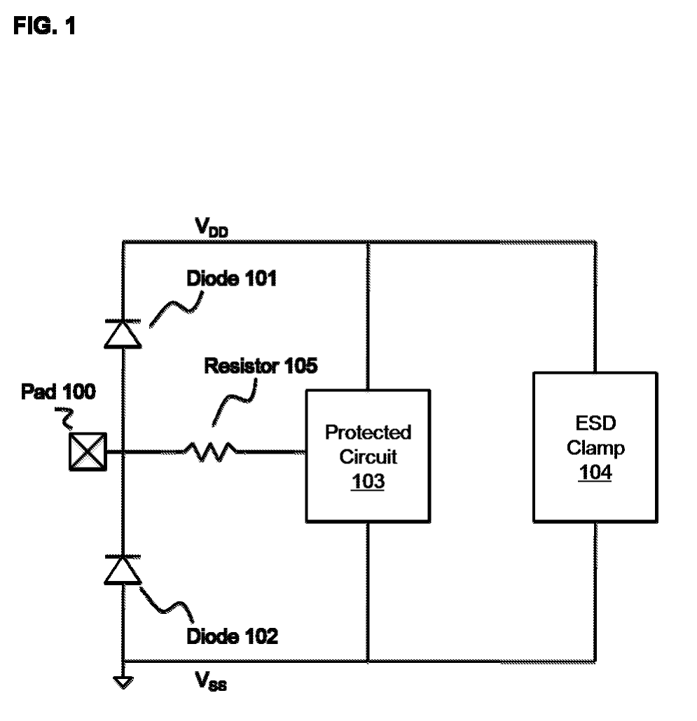

FIG. 2 illustrates an ESD power clamp using an NMOS transistor.

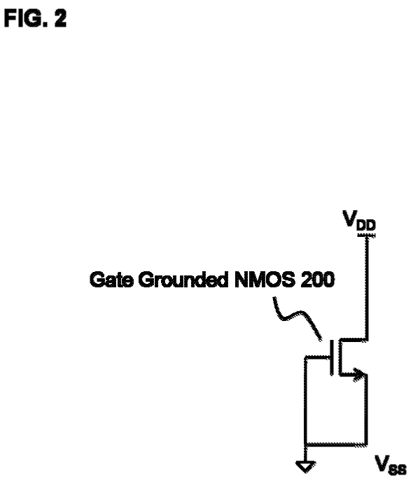

FIG. 3 illustrates an RF Power Amplifier.

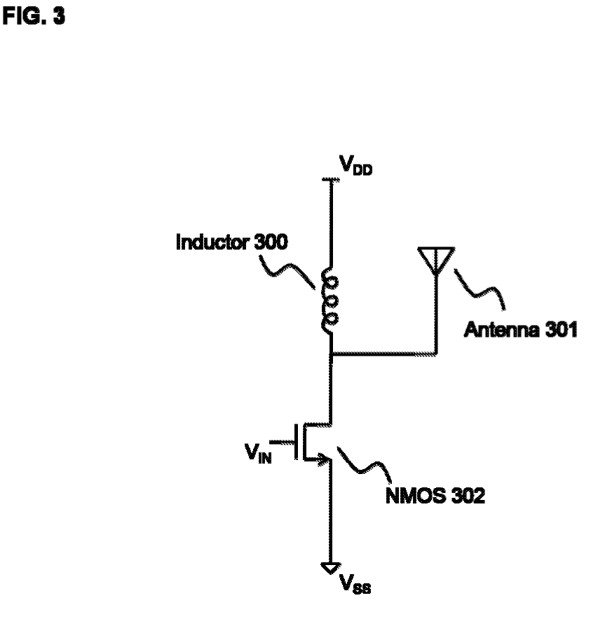

FIG. 4 illustrates a circuit for protecting RF internal circuitry from ESD events using LC resonance masking.

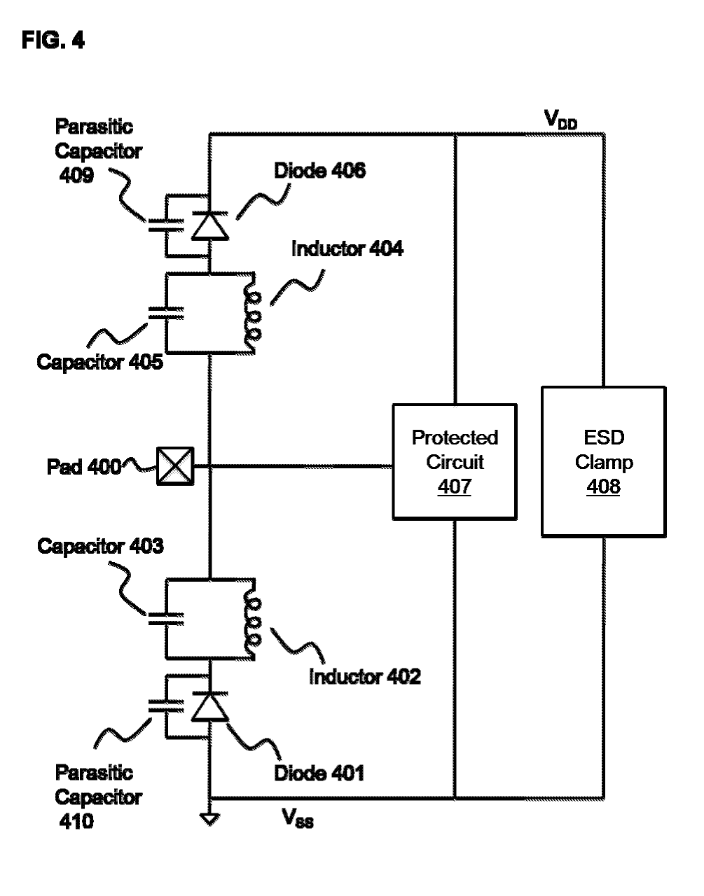

FIG. 5 illustrates a circuit for protecting RF internal circuitry from ESD events that is consistent with the present invention.

FIG. 6 illustrates a circuit consistent with the present invention and demonstrates the invention's advantage for smaller geometries.

FIG. 7 displays a block diagram of a method that is an embodiment of the present invention.

### DETAILED DESCRIPTION OF THE PREFERRED EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used on another embodiment to yield a still further embodiment. Thus, it is intended that the present subject matter covers such modifications and variations as come within the scope of the appended claims and their equivalents.

Known resonance isolation techniques and parasitic matching circuits can be very effective. However, both techniques require tuning or an exacting design. Parasitic matching circuits require tuning because the exact capacitive parasitic of ESD protection devices will vary from part to part and depend on many variant factors of the manufacturing process. The resonance matching circuits also need to be tuned or designed with extreme care such that the resonant frequency of the LC pair used to isolate the devices matches the operating frequency of the internal circuit. In addition, if the circuit operates at varying frequencies, then the LC pair has to be adjusted each time the circuit shifts operating frequencies.

The circuit techniques that use additional inductors as low impedance shunts do not require delicate tuning if they don't also use specialized ESD devices. These circuit types can function without specialized ESD devices, such as diodes connected to the I/O pins, because the inductors are less susceptible to damage from ESD events. Passive devices such as inductors can be damaged by metallization melt and other failure mechanisms when forced to carry large currents. However, these devices are more robust than the transistors that form the other connection to the I/O pin in a PA. Therefore, the inductor serves as the ESD protection device for the transistor and the circuit does not need an additional ESD device to protect the inductor itself. Although these circuits do not require specialized ESD devices, they will still require significant area and cost. Passive devices can be some of the most area hungry parts of an integrated circuit design. The additional ESD inductors will consume area and could also require that the original inductor be made larger for targeting the same performance. Inductors placed in parallel between two nodes generate effective impedance less than the impedance of the individual inductors. Therefore, if an additional ESD shunt inductor is added in parallel to the operating circuit's inductor, the original inductor may need to be increased in size which will result in additional cost.

The drawbacks inherent in the prior art are not shared by a circuit that uses the tank inductor of the power amplifier itself as a single polarity ESD protection device. If too much voltage is applied across the amplifier's active device, then the tank inductor can provide a shunt to ground. The inductor can be selected to take advantage of the fact that ESD events tend to have lower frequencies than the operating frequency of the amplifier. The inductor will therefore have a large impedance when needed to amplify the signal at the operating frequency and a lower impedance to provide an easier route for the ESD pulse to shunt at lower frequencies. An added benefit of the invention is that its ESD protection capability will improve as the ever continuing march towards smaller geometries continues. Although this technique is contrary to the focus of the previously discussed prior art, the invention has been reduced to practice, has been found operable, and exceeds minimum industry standards in performance.

The intrinsic inductor ESD protection technique has the advantage of not requiring any matching for the ESD protection devices because there are none. The solution for how to make the ESD devices invisible to the circuit when the circuit is at its regular operating frequency was to have the ESD protection devices be an actual part of the circuit operating in its regular manner. The circuit also has an advantage over the prior art in that a separate inductor for providing the shunt to ground is no longer needed. This results in size and costs savings.

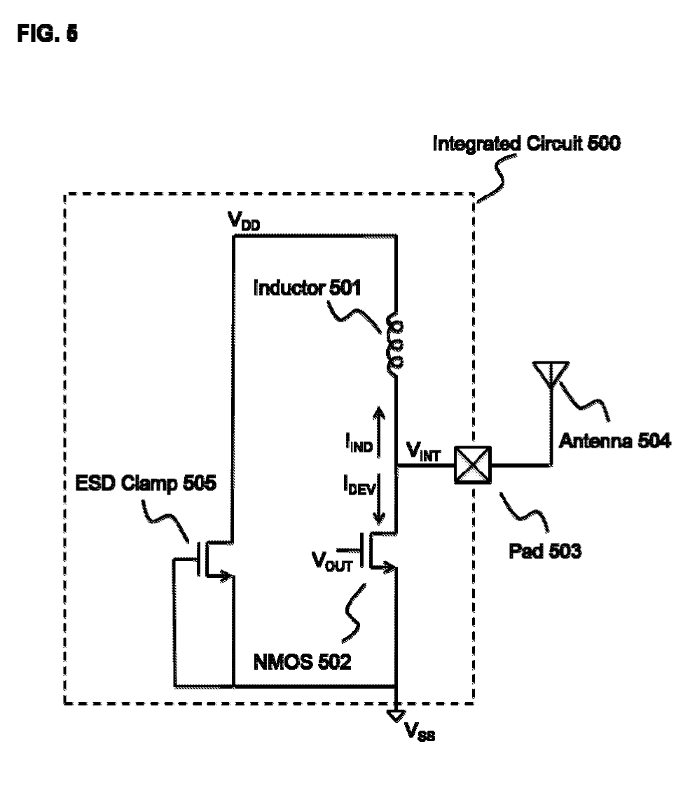

FIG. 5 displays a simplified diagram of a specific embodiment of the invention. The RF ESD protection circuit in FIG. 5 is comprised of antenna 504 and an integrated circuit radio 500. Integrated circuit 500 is connected to antenna 504 at bond pad 503. ESD signals will affect the circuit by producing a large current or voltage at bond pad 503 which is coupled to the internal circuit through node V_{INT}. The ESD current will affect the circuit in the form of currents marked I_{IND} and I_{DEV} and the voltage at V_{INT}. For ESD events that bring the voltage at V_{INT} down towards and below V_{SS} current will flow from V_{DD} through tank inductor 501 and out of the circuit through bond pad 503. Although the ESD current will be flowing through inductor 501 the device can be manufactured to be sufficiently robust so that it can withstand higher currents.

The transistor of the PA will not be able to withstand ESD events in the same manner as the tank inductor withstands ESD events with the opposite polarity. An ESD event with the opposite polarity of that previously discussed will bring the voltage at V_{INT} up to and beyond V_{DD}. Depending upon the voltage at V_{OUT}, either a large voltage will build up across transistor 502 and exceed the punch-through voltage causing dielectric breakdown or a large current will flow through transistor 502 causing thermal breakdown. A combination of both failure mechanisms is also possible. However, with a proper size selected for inductor 501, the voltage at V_{INT} and current I_{DEV} can be kept within the range that transistor 502 can withstand without damage. Inductor 501 will have lower impedance than is necessary for amplifying the operating signal at the lower frequency ESD events. This lower impedance path will allow current to flow through inductor 501 instead of transistor 502 while keeping the voltage at node V_{INT} low. As the voltage at V_{DD} increases ESD clamp 505 will trip and shunt current from V_{DD} to V_{SS}. The ESD current will therefore ultimately be kept away from harming transistor 502.

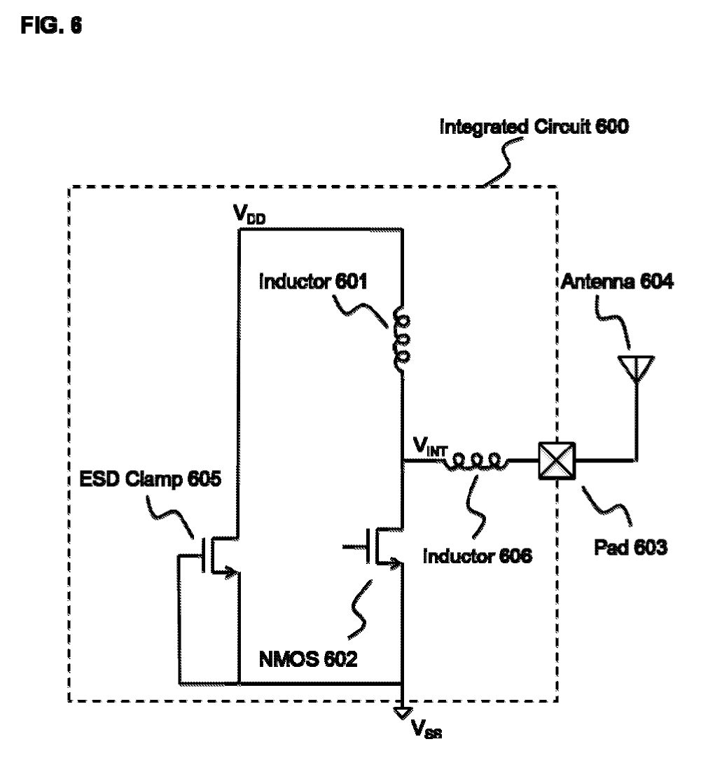

An added benefit of the intrinsic inductor technique is that the capability of the ESD circuit will improve with decreasing geometries. This is advantageous due to the aforementioned fact that decreasing geometries are more susceptible to ESD failure. The improved performance of this ESD protection scheme with decreasing geometries can be explained with reference to the RF ESD protection circuit with impedance matching illustrated in FIG. 6. As a technology scales to lower geometries the V_{DD} supply voltage scales down as well. The power delivered to antenna 604 from integrated circuit 600 is not scalable with technology as it depends on the desired range and performance of the radio. The power delivered to the antenna is proportional to the voltage swing and inversely proportional to the output resistance seen at node V_{INT}. The voltage swing decreases with V_{DD} so to maintain the same power delivery to the antenna the output resistance needs to decrease also. It is therefore necessary to decrease the size of inductor 601. However, there needs to be impedance matching between the antenna 604 and the source impedance set by inductor 601 and transistor 602. The impedance of the antenna is not scalable and is typically in the range of 50-100 Ohms. It is therefore necessary to include tapped inductor 606 to act as an impedance transformation to maintain matching between the decreasing inductor 601 and antenna 604. Although this requires a certain degree of adaptive design effort the end result is a decreased inductor 601 with the same power performance. This is beneficial because ESD events at pad 603 will see an even lower impedance path through inductor 601 due to the decreased inductance. Therefore, when an ESD event occurs even more energy will be diverted through inductor 601 and clamp 605 to V_{SS} which increases the protection of transistor 602.

There are several other PA configurations to which this invention may be applied. For example, in FIG. 5, inductor 501 could instead be connected from V_{INT} to V_{SS} and transistor 502 could be replaced by a p-type metal oxide semiconductor (PMOS) coupled to V_{INT} and V_{DD}. The inductor will still function as an ESD protection device and as a load or bias inductor for the PA in such a situation. When the circuit is introduced to an ESD pulse the voltage at V_{INT} will drop down away from V_{DD} and increase the voltage across the PMOS. When this occurs current will be provided through the ESD clamp to V_{SS} and then through the inductor to increase the voltage at V_{INT} and protect the PMOS device. This is the same action of the inductor in the NMOS case with polarities flipped. In addition, the invention can also be embodied in a BJT PA where the PMOS and NMOS transistors in the previous discussions can be replaced by PNP and NPN BJTs respectively.

Certain techniques can be used in combination with the selection of an adequately sized inductor to increase the ESD protection performance of the circuit. For example, other types of clamps such as silicon controlled rectifiers can be used in place of the gate grounded NMOS device. Also, the clamp can be placed in close proximity to the pad to improve the reaction of the clamp to ESD pulses. The PA transistor itself can be modified to improve its resilience to ESD events. A series resistor can be applied to couple the drain contact from node V_{INT} to the gate covered region of transistor 502. Alternatively, a lesser number of contacts can be used to couple the drain of transistor 502 to node V_{INT} than are usually used. Either of these configurations will effectively create a series resistance on the drain of transistor 502 that will act to limit the current that flows to the transistor instead of the inductor.

The invention will also function with other I/O structures attached to the same pad as the PA. For example, a Low Noise Amplifier (LNA) input could also be attached to the pin and the PA's intrinsic inductor would still provide ESD protection to the transistors coupled to the pad. Also, the ESD protection inductor does not have to be the tank inductor of the PA. An inductor used to bias the I/O node could also be used to provide the same effect.

An embodiment of the invention was reduced to practice and tested using the HBM and Machine Model (MM) industry standard. A differential output PA output driver pin was tested using the intrinsic inductive shunt ESD protection method and a PA transistor with sparse contacts. The invention performed better than the industry standard. The industry HBM standard is 2000V and the device performed up to 8000V. The industry MM standard is 200V and the device performed up to 450V.

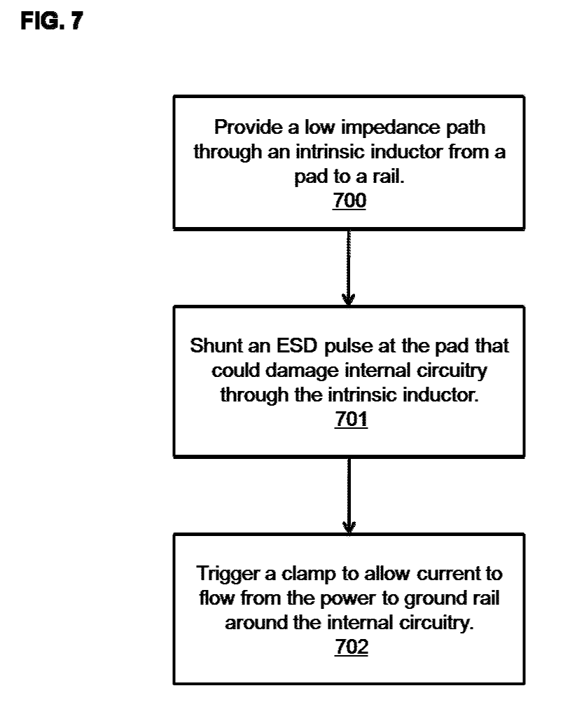

A method that applies the invention can be discussed with reference to the flow diagram illustrated in FIG. 7. FIG. 7 illustrates a particular manner in which the invention can be utilized to protect an internal circuit from damage caused by an ESD event. In step 700 a low impedance path is provided from a pad to a rail. The path is through an inductor that is used during regular operation as a tank or bias inductor for a PA connected to the pad. For example, if the active device of the PA was an NMOS the rail that the inductor would be connected to would be the power rail. In step 701 the energy of an ESD pulse is shunted from the pad through the inductor as the inductor provides a low impedance path that has an impedance that decreases with decreasing frequency. In step 702 an ESD clamp is triggered that either provides current to the rail in question if the rail is the ground rail or pulls current from the rail in question if the rail is the power rail. Thus the clamp and inductor keep the energy of the ESD pulse from affecting and damaging the active device by providing an alternate route around the circuit.

Although embodiments of the invention have been discussed primarily with respect to specific embodiments thereof, other variations are possible. Various configurations of RF input and output circuits may be used in place of, or in addition to, the circuit configurations presented herein. The invention is not limited to use with silicon and can be applied to any semiconductor material including compound semiconductors. Functions may be performed by hardware or software, as desired. In general, any circuit diagrams presented are only intended to indicate one possible configuration, and many variations are possible. Those skilled in the art will also appreciate that methods and systems consistent with the present invention are suitable for use in a wide range of applications encompassing any involving protection of circuitry from large current and voltage signals. While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims. Furthermore, those skilled in the art will appreciate that the foregoing description is by way of example only, and is not intended to limit the invention.

What is claimed is:

1. An intrinsic inductive shunt electrostatic discharge (ESD) protection circuit for providing efficient electrostatic discharge protection to an RFIC, comprising:
an inductor coupled from a first rail to an internal node;
a power amplifier transistor having a transconductance control node coupled to internal circuitry, a first terminal coupled to a second rail, and a second terminal coupled to an internal node; and
a pad coupled to said internal node, capable of being coupled to off chip systems, and free of any particularized ESD protection devices;
wherein said power amplifier transistor serves as the active device for an RF power amplifier;

2. The intrinsic inductive shunt electrostatic discharge protection circuit of claim 1, wherein said inductor acts as one of either a bias inductor or a tank inductor for said RF power amplifier.

3. The intrinsic inductive shunt electrostatic discharge protection circuit of claim 2, wherein said inductor also acts as a low impedance path to said first rail to protected said at least one power amplifier transistor during an ESD pulse.

4. The intrinsic inductive shunt electrostatic discharge protection circuit of claim 3, wherein said low impedance path can provide adequate protection such that said pad may exceed industry specifications for the Human Body Model (HBM) test at 2000V and the Machine Model (MM) test at 200V.

5. The intrinsic inductive shunt electrostatic discharge protection circuit of claim 2, further comprising an ESD clamp circuit with a positive terminal coupled to a power rail and a negative terminal coupled to a ground rail; wherein said power rail and said ground rail are one of said first rail and said second rail respectively or said second rail and said first rail respectively.

6. The intrinsic inductive shunt electrostatic discharge protection circuit of claim 5, wherein said ESD clamp is a gate grounded NMOS transistor.

7. The intrinsic inductive shunt electrostatic discharge protection circuit of claim 6, wherein said inductor also acts as a low impedance path to said first rail to protected said at least one power amplifier transistor during an ESD pulse.

8. The intrinsic inductive shunt electrostatic discharge protection circuit of claim 7, wherein said low impedance path can provide adequate protection such that said pad may exceed industry specifications for the Human Body Model (HBM) test at 2000V and the Machine Model (MM) test at 200V.

9. The intrinsic inductive shunt electrostatic discharge protection circuit of claim 5, wherein said ESD clamp is placed nearby the pin to ensure a rapid snapback reaction during an ESD event.

10. The intrinsic inductive shunt electrostatic discharge protection circuit of claim 2, wherein said inductor is part of an impedance transformation network.

11. The intrinsic inductive shunt electrostatic discharge protection circuit of claim 10, wherein said pad is coupled to said internal node via a tapped inductor sized for impedance matching said RF power amplifier to said off chip systems.

12. The intrinsic inductive shunt electrostatic discharge protection circuit of claim 10, wherein said inductor acts as one of either a bias inductor or a tank inductor for said RF power amplifier.

13. The intrinsic inductive shunt electrostatic discharge protection circuit of claim 12, wherein said inductor also acts as a low impedance path to said first rail to protected said at least one power amplifier transistor during an ESD pulse.

14. The intrinsic inductive shunt electrostatic discharge protection circuit of claim 13, wherein said low impedance path can provide adequate protection such that said pad may exceed industry specifications for the Human Body Model (HBM) test at 2000V and the Machine Model (MM) test at 200V.

15. The intrinsic inductive shunt electrostatic discharge protection circuit of claim 2, wherein said pad also serves as an input for a second RF system.

16. The intrinsic inductive shunt electrostatic discharge protection circuit of claim 15, wherein said second RF system is a Low-Noise Amplifier (LNA) mixer.

17. The intrinsic inductive shunt electrostatic discharge protection circuit of claim 2, wherein said power amplifier transistor is one of a PMOS transistor or an NMOS transistor.

18. The intrinsic inductive shunt electrostatic discharge protection circuit of claim 17, wherein said PMOS transistor and said NMOS transistor have one of either series resistance on said second terminal or sparse contacts on said second terminal.

19. A method for protecting an internal radio frequency (RF) circuit from electrostatic discharge (ESD) events using an intrinsic inductive shunt, comprising the steps of:
providing a frequency dependent low impedance path to a rail from a pad through an inductor that acts as a bias inductor or a tank inductor during normal operation;
shunting the energy of an ESD event through said frequency dependent low impedance path to protect an active device connected to said pad that acts in tandem with said inductor as a power amplifier during normal operation;
triggering an ESD clamp in response to said shunting such that said energy is transferred through said clamp from said rail to a second rail such that said active device is protected from damage caused by said ESD event.

20. The method of claim 19, wherein said pad is free of any particularized ESD protection devices.

21. The method of claim 20, wherein said low impedance path sufficiently protects said active device such that said pad may exceed industry specifications for the Human Body Model (HBM) test at 2000V and the Machine Model (MM) test at 200V.
